(19) United States
(12) Patent Application Publication
(10) Pub. No.: US 2025/0173687 A1
(43) Pub. Date: May 29, 2025

(54) System and Method for Predictive Maintenance and Parts-Manufacturing Optimization

(71) Applicant: Vincent Loccisano, Wellesley, MA (US)

(72) Inventor: Vincent Loccisano, Wellesley, MA (US)

(21) Appl. No.: 19/040,360

(22) Filed: Jan. 29, 2025

(51) Int. Cl. G06Q 10/20; G06Q 50/04

(52) U.S. Cl. CPC G06Q 10/20; G06Q 50/04

(57) ABSTRACT

A system and method for predictive maintenance of a fleet of vehicles employs machine-learning algorithms and statistical analysis to predict when vehicles will require maintenance. This optimizes the manufacture of spare parts by aligning parts-production with future demand. The system assists vehicle manufacturers in meeting supply-chain demands as future demand is predicted and as new technologies are implemented.

### TECHNICAL FIELD

The present disclosure relates generally to the field of vehicle maintenance, parts manufacturing, and inventory management.

### BACKGROUND OF THE INVENTION

Maintaining a fleet of vehicles requires periodic maintenance checks. These checks often occur after parts fail, and often result in unexpected downtime and inefficiencies in part-inventory management. Systems like these are particularly inefficient when the failure indicates a fleet-wide issue that could have been anticipated, as happens when a particular component fails at a fixed age, regardless of mileage.

Vehicle dealers often offer service contracts and maintenance plans to fleet owners. These agreements can cover a wide range of services from routine maintenance such as oil changes and tire rotations to major repairs. This provides fleet managers with predictable maintenance costs. Many dealers use online systems to manage fleet maintenance records, track service history and schedule appointments. These systems provide fleet managers with real-time updates on the status of their vehicles and any necessary repairs. Dealers can often offer discounts on parts and labor for fleet customers due to the volume business and are typically able to keep a stock of commonly used parts for fleet vehicles to expedite repairs.

Many modern vehicles have a built-in cellular modem similar to a smartphone. This allows the vehicle to be connected to a cellular network and to transmit data to the cloud. Types of information transmitted may be broadly categorized as vehicle diagnostics and performance data, location and navigation data, and Advanced Driver Assistance System (ADAS) and safety data. Diagnostics and performance data may include engine temperature, oil pressure, fuel consumption, battery temperature voltage and overall battery health, fault codes and mileage usage data. Location and navigation data may be used for GPS location, traffic information and the like. ADAS and safety data may include data from on-board cameras and sensors and information about accidents including impact forces and airbag deployment.

Information and data uploaded to the cloud is commonly used by manufacturers to analyze vehicle data to predict potential maintenance needs, for remote diagnostics or to send software updates to vehicles remotely.

A centrally located network, also referred to as a centralized network, relies on a central node such as a server or hub, to manage and control communication between connected devices or clients in the network. In this architecture, all data passes through the central node. The central node is responsible for routing, processing and storing information. A centralized network offers advantages including reliability of data, simplified management, and security. Drawbacks to a centralized network include bottlenecks under heavy traffic, and single-point failure.

A distributed network architecture distributes data and processing actions across multiple interconnected nodes. Decentralization offers inherent advantages in the way of fault tolerance and resilience as the failure of one node does not necessarily disrupt the entire network.

Reactive maintenance addresses failures after they occur. Preventative maintenance follows fixed schedules. A predictive system would use data analysis and machine-learning to forecast potential equipment failures before they happen. A predictive approach to equipment and vehicle maintenance minimizes vehicle downtime, reduces maintenance costs, and can optimize asset performance across various industries.

### SUMMARY OF THE INVENTION

An example embodiment is a system and method for predictive maintenance of a fleet of vehicles. The system and method employs machine-learning algorithms and statistical analysis to predict when vehicles, and particularly fleet vehicles, will require maintenance, optimizing the manufacture of spare parts by aligning parts-production with future demand. Additionally, this system assists vehicle manufacturers in meeting supply-chain demands as future demand is predicted and as new technologies are implemented.

In an example embodiment, a data-collection module receives real-time and historical data from each vehicle in a fleet. A machine-learning engine processes the received data to develop predictive models. A predictive algorithm employs the machine-learning models to forecast the likelihood of component failures or maintenance requirements. A manufacturing-control system receives maintenance forecasts and adjusts the production schedule for parts to align with predicted demand. A supply-chain integration module interfaces with the manufacturer's supply-chain management system to anticipate and prepare for demands for anticipated maintenance and for the implementation of new vehicle technologies.

In some embodiments the data-collection module, machine-learning engine, predictive algorithm, manufacturing control system and supply chain integration module reside on a centralized network. This embodiment is particularly useful when a single set of received data is desirable or when security is of concern.

In other embodiments the data-collection module, machine-learning engine, predictive algorithm, manufacturing control system and supply chain integration module reside on a distributed network. This embodiment is particularly useful when a consensus of received data is desirable and when resilience is of concern over security. In this embodiment, individual components do not need to be in the same geographic location. A machine-learning engine or predictive algorithm, needn't be in proximity of a data-collection module, and may be in a separate time zone, for example.

The present disclosure applies to a variety of vehicles and fleets. For the purposes of this disclosure the invention is described in the context of Original Equipment Manufacturers (OEM). The term fleet may refer to vehicles that are automobiles, trucks or buses. The term fleet may also refer to vehicles that make up a fleet of aircraft including drones. In other examples, the term fleet may refer to vehicles that are boats, ships, or submarines. Vehicles may refer to these automobiles, boats and aircraft and may refer to civilian, commercial or military vehicles.

### BRIEF DESCRIPTION OF DRAWINGS

FIG. 1 is a diagram illustrating the components of the system and method.

FIG. 2 is a diagram showing the system and method's mode of operation.

### DETAILED DESCRIPTION

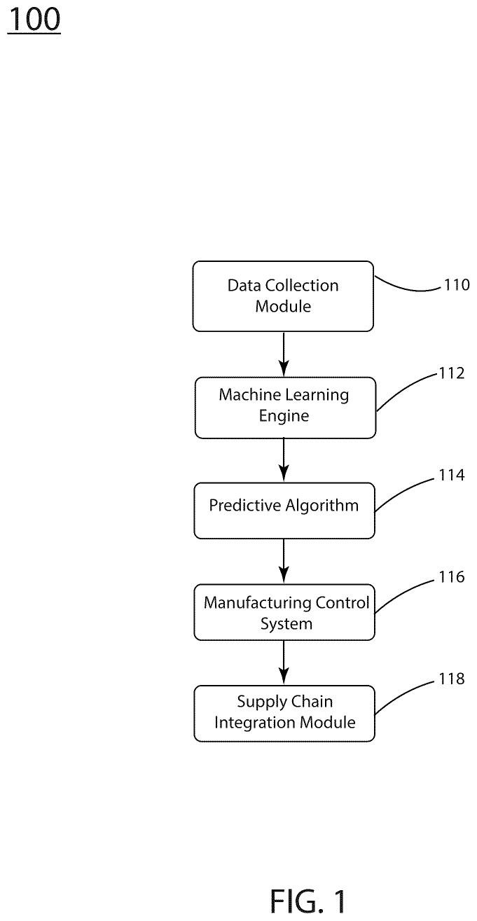

The diagram in FIG. 1 describes the parts of the system and method. A data-collection module 110 receives and stores real-time and historical data, including engine performance, mileage, usage patterns, sensor readings, and maintenance logs, from each vehicle in the fleet. A machine-learning engine 112 processes the collected data to develop predictive models. These models use algorithms to analyze patterns and predict future maintenance or warranty needs.

A predictive algorithm 114 uses the machine-learning engine to forecast the likelihood of component failures or maintenance requirements. The algorithm continuously refines its predictions as it receives new data. This data may include fleetwide failure rates as reported by service centers, fleetwide failure rates as reported by the vehicles themselves (based on ECU data), or fleetwide updates such as accrued operating hours, mileage or fuel usage at various RPM's as reported by individual vehicles within the fleet.

A manufacturing-control system 116 receives maintenance forecasts and adjusts the production schedule for spare parts to align with predicted demand, ensuring optimal inventory levels.

A supply-chain-integration module 118 interfaces with the manufacturer's supply-chain management systems to anticipate and prepare for increased demands associated with the implementation of new vehicle technologies. This manufacturing control system may be maintained by the vehicle fleet owner or may be part of a third party network.

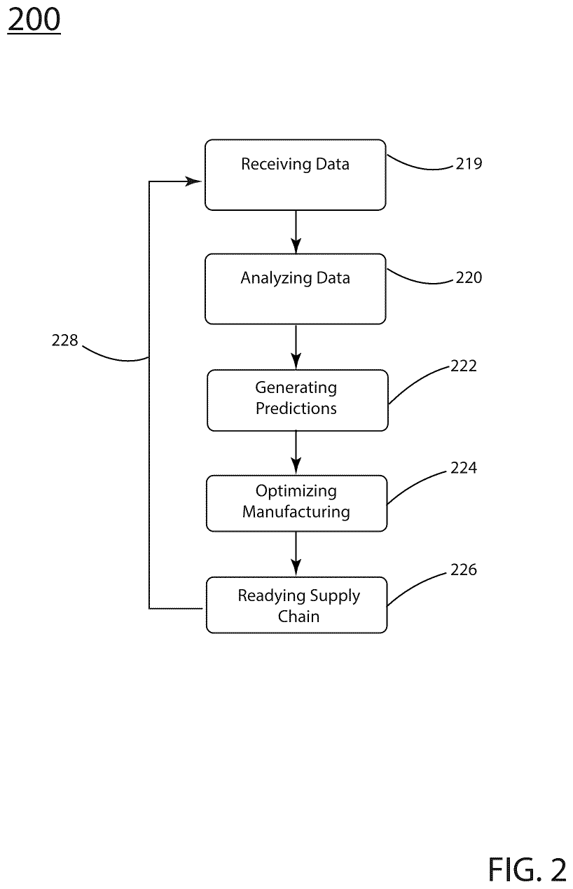

The diagram of FIG. 2 shows the system and method's mode of operation. The data collection module 110 (FIG. 1), receives real-time and historical data from one or more vehicles in a fleet of vehicles. The machine-learning engine 112 (FIG. 1), analyzes data 220 received from the fleet, identifying patterns that indicate potential maintenance needs. With that analysis, the predictive algorithm generates predictions of maintenance requirements 222 for each vehicle. Predictions, or forecasts, include the type of maintenance needed, the specific components at risk, and an expected timeframe for performing the maintenance.

The manufacturing-control system uses the maintenance forecasts to adjust a production schedule for spare parts, ensuring that parts are manufactured in alignment with anticipated demand. This optimizes manufacturing 224 by minimizing the risk of overproduction, reducing inventory costs and ensures JIT delivery of required items based on fleetwide and geographic needs. This further de-risks part manufacturing as multiple suppliers may be utilized to ensure anticipated demand is met in a timely manner.

A supply chain is prepared 226 by the supply-chain integration module (FIG. 1, 118), which uses predictive data to help vehicle manufacturers anticipate demand for new technology components. This ensures that manufacturing and supply-chain processes are aligned, reducing the risk of part shortages as well as facilitating smoother transitions when new technologies are introduced.

1. A system for predictive maintenance and optimization of spare parts manufacturing, comprising:
a data-collection module that receives real-time and historical data from at least one vehicle of a fleet of vehicles;
a machine-learning engine that processes the received data to develop predictive models;
a predictive algorithm that uses the machine learning models to forecast vehicle maintenance needs;
a manufacturing-control system that adjusts the production schedule for spare parts based on the maintenance forecasts;
a supply-chain integration module that interfaces with the manufacturer's supply-chain management systems; wherein
increased demands associated with multiple vehicle part replacement requirements and implementation of new vehicle technologies are anticipated and prepared for.

2. The system of claim 1 wherein:
the system resides on a centralized network.

3. The system of claim 1 wherein:
the system resides on a distributed network.

4. The system of claim 1, wherein:
the data-collection module receives data including mileage and number of hours of use from the at least one vehicle of the fleet of vehicles to inform the machine-learning engine and predictive algorithm to determine anticipated failure of at least one component.

5. The system of claim 1, wherein:
the data-collection module receives data including component performance and anticipated degradation over time from the at least one vehicle of the fleet of vehicles to inform the machine-learning engine and predictive algorithm to determine anticipated degradation of component performance.

6. The system of claim 1, wherein:
the data-collection module receives engine performance, usage patterns, sensor readings, and maintenance logs from the at least one vehicle of the fleet of vehicles to determine anticipated failure of at least one component.

7. The system of claim 1 wherein:
the data-collection module receives data including operating temperature and vibration analysis; wherein
temperature and vibration data is provided to the machine-learning engine that further informs the predictive algorithm to forecast vehicle maintenance needs.

8. The system of claim 1, wherein:
the data-collection module receives geographic operating data; wherein
the location of the vehicle is provided to the machine-learning engine that further informs the predictive algorithm to forecast vehicle maintenance needs.

9. The system of claim 1, wherein:
the predictive algorithm generates forecasts including the type of maintenance needed, specific components at risk, and the expected timeframe for maintenance performance.

10. The system of claim 1 wherein:
the predictive algorithm forecasts the status of a warranty of the at least one vehicle at a time of component failure.

11. The system of claim 1, wherein:
the manufacturing-control system optimizes the production of spare parts to align with predicted maintenance demand, reducing inventory costs.

12. The system of claim 1, wherein:
the supply-chain integration module helps vehicle manufacturers anticipate demand for new technology components, reducing the risk of part shortages and facilitating extended fleet uptime without component failure.

13. A method of using the apparatus of claim 1, the method comprising:
receiving data in the data-collection module; and
analyzing the received data through a machine-learning engine; and
generating predictive models for parts to be required based on analyzed data; and
optimizing manufacturing to prepare to meet the needs of the predictive models; and
readying a supply chain to meet the needs of the predictive models.

14. The method of claim 13 further comprising:
receiving data through a centralized network.

15. The method of claim 13 further comprising:
receiving data through a distributed network.
